(19) United States
(12) Patent Application Publication
(10) Pub. No.: US 2006/0193687 A1
(43) Pub. Date: Aug. 31, 2006

(54) Moment resisting frame bearing connector

(76) Inventor: Avik Ghosh, Monterey Park, CA (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/333,294

(22) Filed: Jan. 18, 2006

Related U.S. Application Data
(60) Provisional application No. 60/644,980, filed on Jan. 21, 2005.

(51) Int. Cl. E06B 3/984

(52) U.S. Cl. 403/401

(57) ABSTRACT

A moment resisting connector and method of using same in connecting support members (e.g., beams and columns) of a moment frame are presented. The moment frame connectors of the invention have a preferred application in wood frames and can provide sufficient rigidity while adequately resisting lateral loads.

### CLAIM OF PRIORITY

This application claims priority to U.S. Patent Application No. 60/644,980, filed Jan. 21, 2004, the disclosure of which is incorporated in its entirety herein by reference.

### FIELD OF THE INVENTION

The present invention relates generally to the field of structural engineering. More specifically, the present invention relates to a connector and method of using same for connecting beams to columns in buildings, bridges and other structures.

### BACKGROUND OF THE INVENTION

Moment frames are in demand in the building construction industry. In residential and commercial applications where wood is heavily used, wooden moment frames are particularly in demand. Moment frames are designed to resist prescribed “lateral loading” from, for example, wind, seismic events, and/or impact loads. One significant aspect of moment frames lies in the connections used in their construction. If detailed properly, the frames can function appropriately and maintain the stability and strength desired when subject to lateral loads.

In the case of wooden moment frames, however, acceptable connectors, providing desirable rigidity, strength, and ductility have been unavailable for use in general structural engineering practice. Instead, structures constructed of wood currently are most commonly further stabilized against excessive lateral loading or movement, for example, by the use of the wooden shearwalls. Although sufficiently strong and ductile, wooden shearwalls can pose nonpreferred constraints in the architectural aspect of design. By way of example, most building codes restrict the use of wooden shearwalls to a minimum length to height ratio, particularly in areas of high seismic activity. These restrictions reduce the amount of wall space available for other items such as windows or doors. Thus, use of a wooden moment frame alone to frame a wall solely with columns and beams could leave more open space for windows, doors, and other preferred items.

However, most engineers heretofore have generally held that the use of a wooden moment frame would be difficult, if not impossible, due to insufficient ductility in the connections used to construct them. For example, current connection methodology comprise nails and bolts, either exclusively or along with straps and other hardware, used in a manner that does not provide sufficient load capacity or tends to split the wood significantly, especially when subjected to cyclic loading. In any event, the current connection methodology is also generally thought to lack the rigidity necessary to adequately provide the requisite stability, resistance, and/or ductility.

Accordingly, there is a need for a moment frame connector that can provide sufficient rigidity while adequately resisting lateral loads. In the case of wooden moment frames, there is a need for a connector that may eliminate or significantly reduce that use of additional stabilizers, such as shearwalls. There is also a need for a moment frame connector that provides a means for connecting wooden beams and columns with significant reduction in splitting of the wood.

### SUMMARY OF THE INVENTION

The foregoing needs are met, to an extent, by the present invention, wherein in one embodiment a connector for connecting a plurality of support members in a moment frame, is provided comprising: (a) a first angled face member and a second angled face member aligned substantially parallel to each other and (b) a plurality of flange members for enclosing the first and the second angled face members to form an angled enclosure with a plurality of entries capable of joining the two or more support members within the entries of the connector. The face members and the flange members form a single unit and may comprise steel, light-gauge metal, aluminum or composite materials such as fiber-plastics. The angled face members may comprise a solid plate, straps, wires, rods, a net, fiber mesh or a combination thereof, and in some embodiments, may further comprise holes to accommodate a fastening means (e.g., nails, screws, pins, bolts and rivets) for fastening the connector to a support member.

In some embodiments, the connector optionally comprises a brace member, preferably of the same material as the rest of the connector, but more commonly comprising steel or light-gauge metal, aluminum or composite material. The angled face members may comprise one, two, three, four, or more angles. In a preferred embodiment, the angle is of about 90 degrees, in which case, the angled enclosure of the inventive connector would also form an angle of about 90 degrees. In other embodiments, one or more of the entries of the connector may further comprise a liner, a bearing distributor, a shear tab and/or a column seat assembly. The liner may comprise epoxy, rubber, grout, plastic, foam, engineered wood or a combination thereof.

In another embodiment of the present invention, a method of constructing a moment frame is provided comprising (a) providing a first and a second support member, (b) providing a moment resisting connector comprising: (i) first angled face member and a second angled face member aligned substantially parallel to each other; (ii) a plurality of flange members for enclosing the first and the second angled face members to form an angled enclosure with a plurality of entries; and (c) joining the first and second support members, in any order, within the connector though any of the plurality of entries. In some embodiments, a third or fourth support member may be provided and in a preferred embodiment, the support members are wooden. The method may further comprise fastening the connector to the first and/or the second support members through the first and/or the second angled face members. Similarly, the method may further include inserting a column seat within the connector when two support members (i.e., columns) are joined.

In yet another embodiment of the present invention, a moment frame is provided comprising (a) a first and a second support member, and (b) a moment resisting connector comprising: (i) first angled face member and a second angled face member aligned substantially parallel to each other; (ii) a plurality of flange members for enclosing the first and the second angled face members to form an angled enclosure with a plurality of entries, wherein the first and second support members are joined within the entries of the connector. In a preferred embodiment, the support members comprise wood.

There has thus been outlined, rather broadly, certain embodiments of the invention in order that the detailed description thereof may be better understood, and in order that the present contribution to the art may be better appreciated. There are, of course, additional embodiments of the invention that may be described below and which may form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art may appreciate that the conception upon which this disclosure is based may readily be utilized as a basis for the designing of other structures, methods and systems for carrying out the present invention. It is important, therefore, that the claims be regarded as including such equivalent constructions.

### BRIEF DESCRIPTION OF THE DRAWINGS

FIG. 1 is an isometric view of one embodiment of a connector in accordance with the present invention.

FIG. 2 is an isometric view of another embodiment of a connector in accordance with the present invention.

FIG. 3 provides several illustrations of different shapes for the optional brace member in accordance with the invention.

FIG. 4A is a side view of one embodiment of a connector in accordance with the present invention.

FIG. 4B is a cross section view of the connector illustrated in FIG. 4A.

FIG. 4C is another cross section view of the connector illustrated in FIG. 4A.

FIG. 5 provides a detail of alternate embodiments of connectors in accordance with the present invention.

FIG. 6 shows the detail of a connector without (A) and with (B) support members, comprising an optional bearing distributor device in accordance with one embodiment of the instant invention.

FIG. 7 depicts detail for a shear-tab and connector assembly in accordance with one embodiment of the instant invention.

FIG. 8 is a non-limiting example of the inventive connector as may be applied in the elevation of a two-story frame.

FIG. 9 is an isometric view of three embodiments of a “framed” connector comprising straps, wires or rods, and net or mesh in accordance with the present invention.

FIG. 10 depicts detail of alternate embodiments of “framed” connectors in accordance with the present invention.

FIG. 11 provides illustrations of different strap designs for the “framed” connectors in accordance with the invention.

FIG. 12 provides yet another illustration of a strap design for the “framed” connectors in accordance with the invention.

FIG. 13 illustrates how a moment frame connection should deform by comparing the deformed shape to the undeformed shape in accordance with the invention.

FIG. 14 depicts moment connectors of the present invention that are not designed to maintain about 90 degree angles.

FIG. 15 is an illustration of how rotational forces, or moments, shears, and axial loads may be transferred between a beam and column via the use of the invention.

FIG. 16 illustrates the use of an optional “column seat” plate assembly.

### DETAILED DESCRIPTION

The invention provides a hardware connector that connects two or more support members. As will be described in further detail below, in a preferred embodiment of the instant invention, the support members may comprise structural beams and/or columns, as in the construction of a rigid frame more commonly known as a “moment resisting frame.” The invention has been described herein, in some part, with application to wooden moment frames comprising wooden beams and columns solely in the interest of clarity. It should be appreciated that the inventive connectors may be applied alone or in conjunction to connections employed in moment frames of any structural material, including, but not limited to, steel, concrete, and combinations thereof.

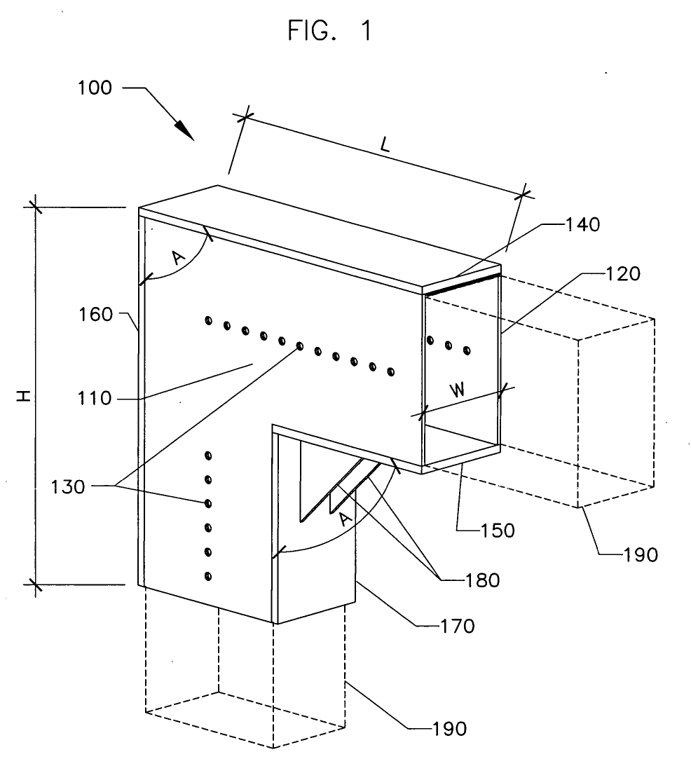

In the interest of clarity, it should be appreciated that not all forms and embodiments of connectors of the present invention have been illustrated. Actual connector dimensions may be expected to change from one application to the next. For example, as shown in FIG. 1, the column depth H may be equivalent to, shorter than, or longer than beam depth L. Similarly, the width W of a connector is subject to vary in accordance with the width required of a support member. Generally, a structural designer is charged to calculate these and other desired connector dimensions in accordance to load and failure specifications of the structure.

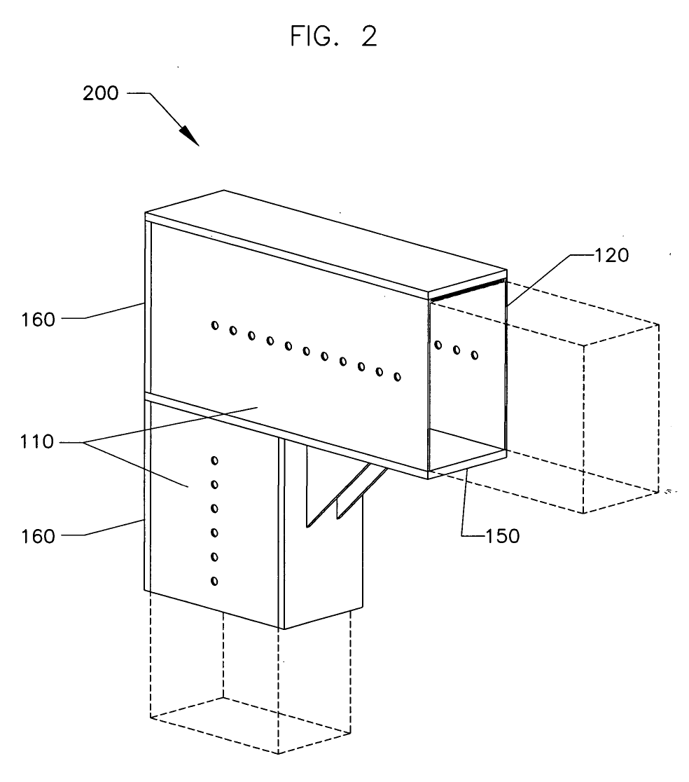

FIG. 1 depicts a connector 100 in accordance with one embodiment of the present invention. Connector 100 comprises a first angled face member 110 and a second angled face member 120 aligned substantially parallel to each other. One or both of the angled face members 110, 120 may optionally be provided with holes 130 for the incorporation of optional fasteners, such as bolts, screws and/or nails. In some embodiments, where fasteners (e.g., “through”-bolts) extend the width W of the connector 100, it is understood that the holes 130 on both angled face members 110, 120 should also be aligned to receive the fastener. The angled face members 110, 120 need not be comprised of a single “angled” piece, but may also be provided as a combination of two or more face members as shown in connector 200 of FIG. 2. In a preferred embodiment, the angled face members 110, 120 form an angle A of about 90 degrees in the absence of any load.

Returning to FIG. 1, the aligned first and second face members 110, 120 are “enclosed” or “capped” by flange members 140 and 150 on one end and flange members 160 and 170 on the other end. As with the face members, the connector illustrated in FIG. 2 shows that the flange members (e.g., 160 and 150) may also be comprised of a continuous single piece or two or more discontinuous pieces. Regardless of the composition, the flange members 140, 150, 160, 170 are preferably designed to the length L and width W of the face members 110, 120. However, there may exist structural and/or aesthetic reasons for asymmetry. Thus, for example, flange member 140 may exceed the length L of the angled face members 110, 120 in some embodiments. Such a requirement may arise in situations where more bearing contact area between the flange member 140 and the support member 190 (e.g., a beam) is required for force distribution, yet aesthetic requirements do not allow the angle face members 110, 120 to extend as well. Simliarly, for example, members 140, 150, 160, and 170 need not necessarily extend to the width W. Such a requirement may arise in situations where manufacturing of the connector is made easier when members 110 and 120 extend past members 140, 150, 160, and 170, thus requiring those members to be W minus the thicknesses of 110 and 120 in width.

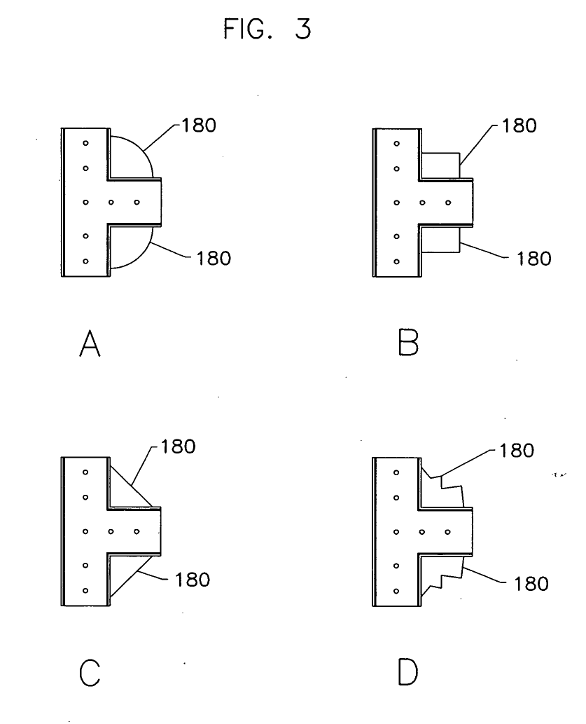

The connector 100 is depicted with two optional brace members 180. Particularly where a greater capacity to transfer the moment via compression or tension into the connector is desired, one or more brace members may be preferred. Inclusion of a brace member may provide a more rigid connection than in its absence, which is desirable for most practical cases. Though the depicted angle/shape of the brace member 180 may suffice in many applications, brace members of the present invention are not limited to any one particular number, shape and/or angle. Some alternative brace member shapes are provided in FIG. 3. These shapes include, for example, rounded, rectangular/square and “custom” designed brace members (FIGS. 3A, 3B and 3C, respectively) or a combination of brace members (FIG. 3D). In any case, however, the brace member 180 should span the angle A of the connector as shown in the figures. In other words, the brace member should brace one support member against another support member joined via the inventive connector. In some applications, multiple brace members may be used concurrently to alleviate the buckling or tensile stress of the bracing member or bending stresses on the flanges 150, 170. See, e.g., FIG. 1.

The structural and mechanical properties of the brace members can affect the capacity to maximally transfer the loads required to maintain a moment connection and also provide adequate ductility when subject to cyclic loads or overstressing. Accordingly, both the shape and material of a brace member may be tailored to meet a prescribed specification. Brace members of the invention may comprise any structural material but preferably comprise the same or similar materials as the rest of the connection hardware, particularly in the interest of economic advantage. Structural steel may be preferable in some embodiments on account of its excellent ductility.

Although connector 100 has been depicted with a rectangular opening (also referred to as “entry” or “sleeve”), it will be appreciated by one of ordinary skill in the art from the disclosure herein that other shapes and dimensions are also possible and to be expected. For example, when used to connect steel “I”-beams, the connector may be designed in an “I” shape to accommodate the steel beam. Such embodiments fall within the scope of the present invention. In a preferred embodiment, the opening need only be sized and shaped to accommodate a support member 190 of complimentary size and shape. More specifically, for constructability reasons, it is preferred that the inner dimensions of the connector are slightly larger than the outer dimensions of the support member it will house.

This manner of construction allows tolerance for relatively smooth insertion of the support member 190 into the connector 100. It may be preferable, however, that the inner diameter not be significantly larger than the outer diameter of the support member 190. In some cases where the entry is significantly larger than the support member, the bearing-tension mechanism of the connector may not be optimal. For example, the outer edges of the connector are then relatively free to impose a concentration of force on the support member which, over time and iterations, may gradually cut away at one or more of the support members. The “cutting away” phenomenon is also referred to herein as “knifing.”

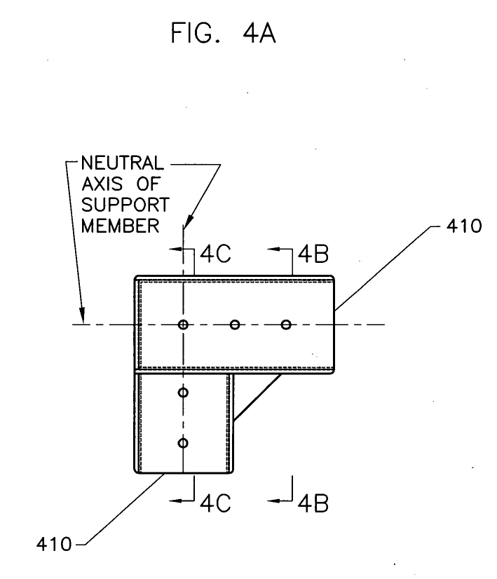

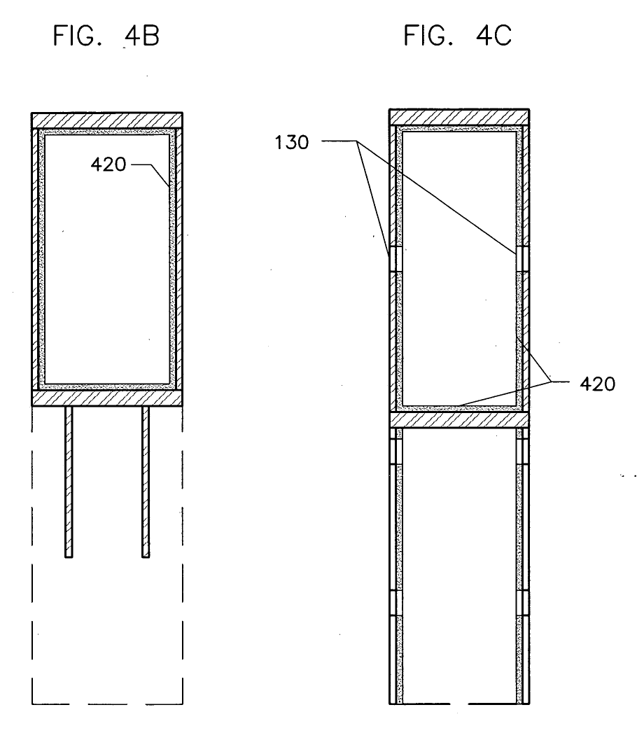

One means for attenuating knifing damage may be to round, taper, cope, or otherwise smooth the outer edges 410 of the connector 400 as depicted in FIGS. 4A and 4B. Alternatively or in conjunction, the inside face of the connector 400 may be lined with a liner 420 (FIGS. 4B and 4C). The liner 420 is preferably a non-compressible, sufficiently rigid substance allowing both transfer of the appropriate forces and a relatively tight fit between a support member and the connector 400. Acceptable liners may comprise, but should not be limited to, epoxy, rubber, grout, plastic, foam, engineered wood, etc. In some embodiments, the liner surface may be “roughened” to better grip and control an inserted support member. More preferable liner materials include concrete grout or epoxy as both of these materials are fluid enough to conveniently apply, yet rigid once hardened or cured. Other examples of such rigid materials include wood, steel, high-strength plastics, or composite materials.

The desirable thickness, compressibility, durability and other properties of the liner 420 may be application-specific. For example, varying thickness of the liner 420 along length L may be desirable to obtain a more advantageous pattern of bearing distribution between face 140 and the top face of support member 190. The inner lining does not need to be on all sides of the beam or column. For instance, a beam can sit directly along the bottom of the connector with no lining at the bottom or the sides, leaving only the top to be filled with inner lining as in FIG. 4C.

Support members may be joined by the inventive connectors through a variety of methods known and available to an ordinary artisan. In some embodiments, the liner 420 may be sufficient. In other embodiments, bolts are preferably used to fasten support members to the connector. Nails, screws, and pins, however, may also be used lieu of or in combination with bolts for a variety of applications. Preferably, any fasteners so employed can adequately transfer all forces associated with the use of the connector. If such “alternative” hardware is used, consideration that nails or screws may not necessarily be engaged in the same manner as that of a through-bolt is preferably taken into account.

Nails, screws, bolts, and other fasteners may comprise any material. Any material so used preferably transfers the associated forces and comfortably ensures that the connector/support member(s) assembly as a whole has sufficient ductility when subject to cyclic loading. Preferably, a structural designer specifies standard construction material properties for all fasteners in accordance with the intended application. Fasteners and the sizes, spacing, and location thereof may also be similarly determined by a structural designer to address application specific needs. Such determinations may be expected and methods for their calculation are generally known to one of ordinary skill in the art.

Preferably, the fastening means are fastened where the bending stress is theoretically at a minimum or nil. In some embodiments, the location of bending stress minimum is along the neutral axis (FIG. 4A) of a supporting member. For example, in a rectangular beam section, such as with a “4×12,” the neutral axis lies along the mid-height of the beam. It is understood that the location may be different for other sections. In applications where the bolt fasteners are used along a line other than the neutral axis of the support member, it may be preferable to check the capacity of the support members and bolts to transfer the associated forces using known methodologies.

One advantage of the inventive connector is that it does not require fasteners such as nails, screws, and bolts to transfer most or any of the bending moment between wood beams and columns because the connector configuration initiates the transfer of such forces by a bearing mechanism before other tensile or shear mechanisms are invoked, if invoked at all. Eliminating the need of fasterners to transfer most, if not all, of the moments allows the invention to be especially useful when subject to cyclic loading, where ductility becomes more of a necessity, since most common fasteners do not always have the capacity to handle such large building forces and can split the wood significantly.

The connectors of the instant invention may be constructed of various materials, but ductile materials such as structural steel or gauge metal are most preferable for cyclic loading events. Materials can either be rolled and bent or molded into the desired shape of the connector. Alternatively, the connector may be assembled together with discreet “plates” (e.g., face and flange members) as shown in the figures. However, it may be preferable for the joints or connection points between the plates to be adequate to transfer most, if not all, of the forces that may result from the bearing transfer of the moment. If steel or gauge metal is used, it is preferred that either the connector is bent and rolled into its desired shape or plates are welded together with standard welding practice. The connector can either be constructed in an assembly facility or on the construction site.

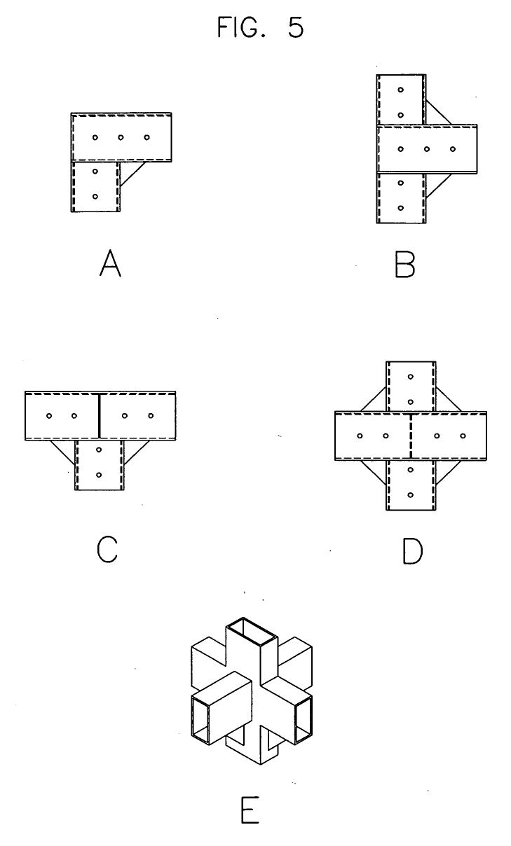

Connectors of the present invention are not limited to joining two supporting members. Indeed, FIG. 5 depicts alternate embodiments of connectors in accordance with the invention. In addition to the “L” configuration (FIG. 5A), which provides a connection between the distal ends of two supporting members (e.g., one column and one beam), the inventive connectors may also embody a “T” configuration (FIGS. 5B and 5C) for connecting three support members at their distal ends or for connecting one support member to the body of one other support member. It should also be apparent to one of ordinary skill in the art from the teachings herein that a beam can be postioned between two columns (e.g., FIG. 5B) or framed onto the side of two adjoining columns. Connectors of the present invention may also adopt a plus (“+”) configuration in both two- and three-dimensions as in FIG. 5D. The plus configuration allows for the connection of four (e.g., two beams with two columns) to six (e.g., four beams with two columns) as in FIG. 5E.

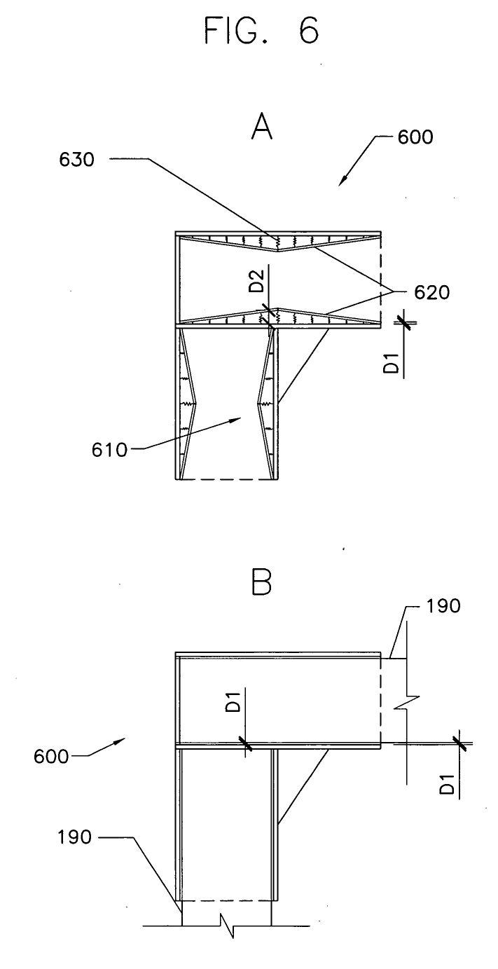

In some embodiments, one or more bearing distributor devices 610 may be incorporated into the connector 600 as shown in FIG. 6A (without suppport members) and 6B (with suppport members). Bearing distributor devices generally consist of a plate 620 attached to a series of spring(s) 630 or any other compressible device or mechanical device with measurable stiffness properties. The size and stiffness of the springs 630 are preferably designed and calibrated such that when positioned in the connector with a plate 620, the springs 630 compress in a combination that produces a more uniform distribution of bearing pressure between a support member and the inner surface of the connector (FIG. 6B) after being loaded. The material properties of the springs, compression devices, and plates are preferably determined based on application specific needs and more preferably are sufficient to transfer the forces imposed on them without localized failure or compromising the overall integrity of the connector as a whole.

Connector 600 may be preferable where the bearing pressure distribution between the connector and the supporting members becomes relatively sharp, resulting in a high and local concentration of bearing stress at one end of the connector. For example, bearing stress between a supporting member and the inner surface of a connector is linearly distributed and maximum in magnitude near the edge of the connector, then a bearing distributor may be inserted such that the springs nearest the maximum level of stress have less stiffness (e.g., are shorter as labeled “D1” on FIG. 6A) than the springs that are near the minimum level of stress (as labeled “D2” on FIG. 6A). In this way, when a support member is inserted into a connector (FIG. 6B), the stiffer springs near the expected minimum stress location along the support member are expected to undergo an initial compression, resulting in “pre-stressing” of bearing on the beam. Similarly, the springs located at the maximum expected bearing pressure are expected to remain relatively uncompressed and yet remain in equilibrium.

Thus, in the event a support member is subject to lateral load, the bearing pressures between the inner surface of the connector and the support member tend to distribute linearly as theorized. More specifically, the springs that were pre-stressed relieve their stress while the springs that were unstressed become stressed, thus resulting in a more uniform bearing pressure distribution. This method of bearing distribution is just one method in which a bearing distributor may be used. Similar applications may be contemplated and fall within the scope of the invention.

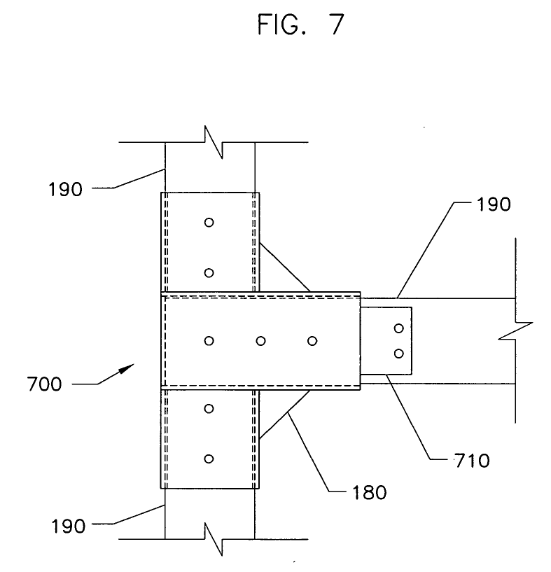

FIG. 7 depicts a connector as described herein in conjunction with additional and optional bracing hardware, such as a shear tab 710 with connector assembly 700. The exact shape, location and size of the shear tab 710 may be determined by one of ordinary skill in the art based on accepted application specific analysis or testing. Preferably, the shear tab 710 is located away from the predicted hinging locations of the beams, such as the beam-column intersection and towards the span of the of beam. For many applications, the use of such a shear tab may be to provide a redundant support for gravity loads upon significant yielding of the beam at its ends The shear tab and bearing plates may be constructed of any material adequate for resisting and transferring the forces associated with the design of the structural system.

Preferably, the shear tab 710 is constructed from the same or similar material as the rest of the connector. The shear tab may be placed on one or both sides of the support member(s) and can be connected to the rest of the connector with any means practiced in the art, for example by welds and/or overlapping the connector and bolting or nailing through the connector. The size, material, and connection to the rest of the hardware may be determined by one of ordinary skill in the art in accordance with the specific application and knowledge in the art.

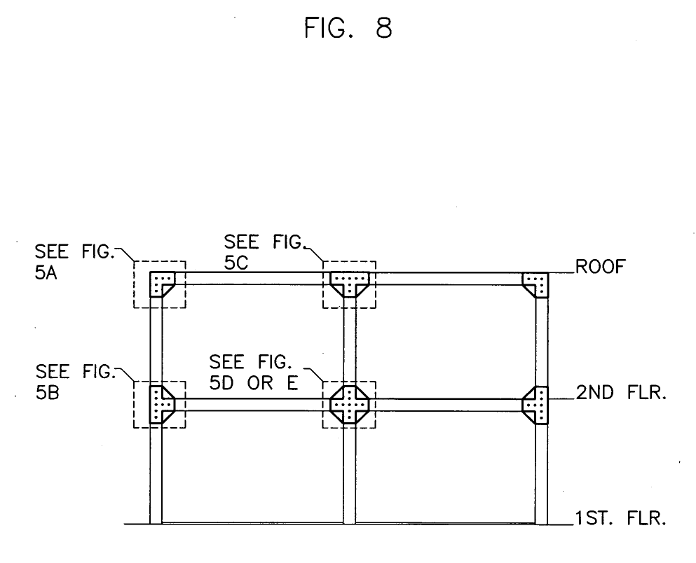

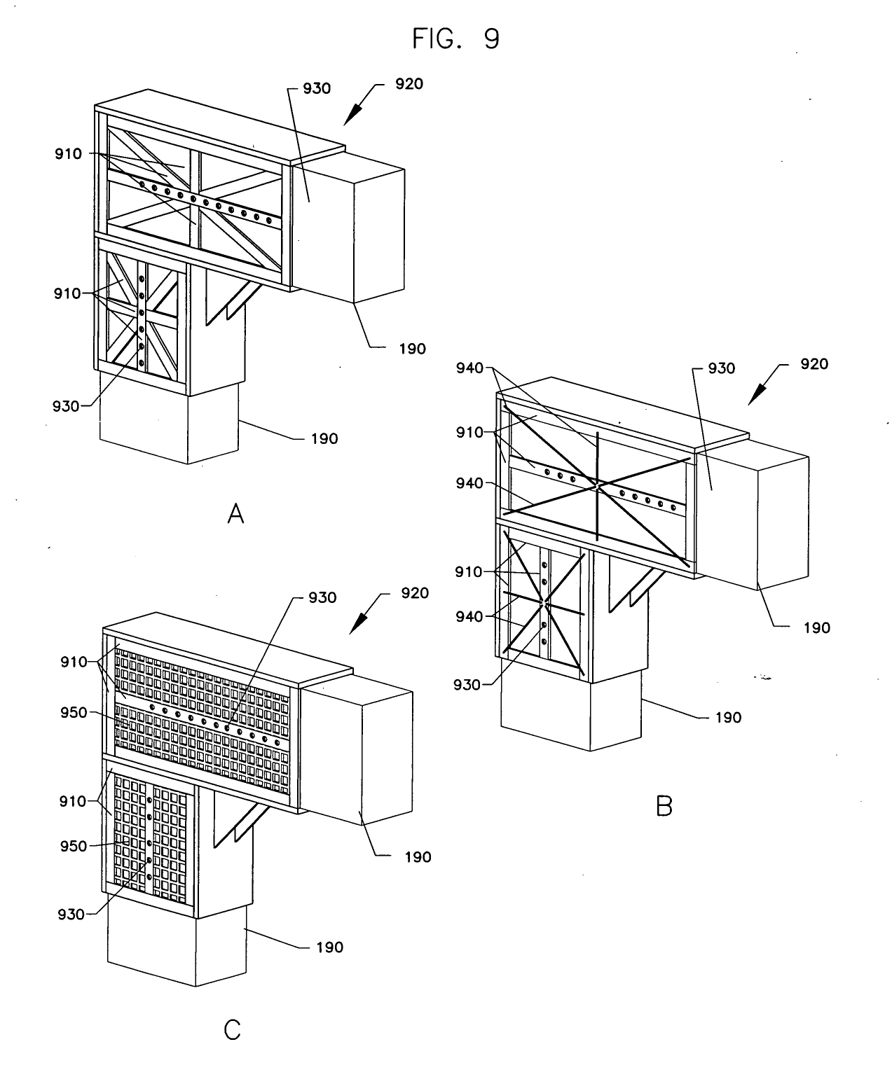

The inventive connectors described herein provide a moment frame connector that can adequately resist lateral and vertical loads in accordance with most generally accepted design and building codes. As shown in FIG. 8, connectors of the present invention may have application at multiple locations in a given moment frame within a given structure. FIG. 8 is a side or elevation view of a two-storied moment frame. Each beam in the diagram is connected to each column by means of an inventive connector. As mentioned above, the particular connector used (e.g., T-shape, L-shape, etc.) will depend on the number of support members to be joined by the connector. It should be noted that the connector may also be used for multi-story applications as well.

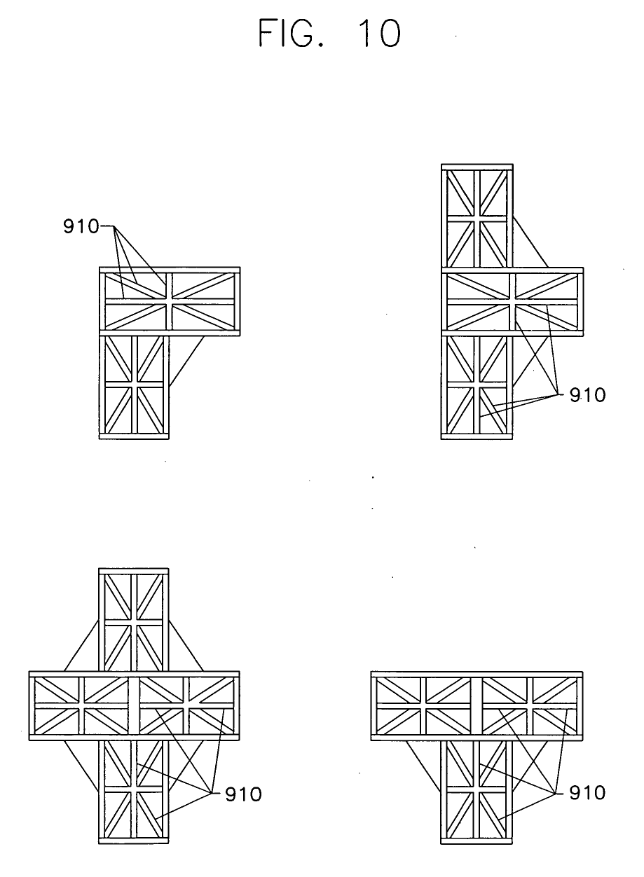

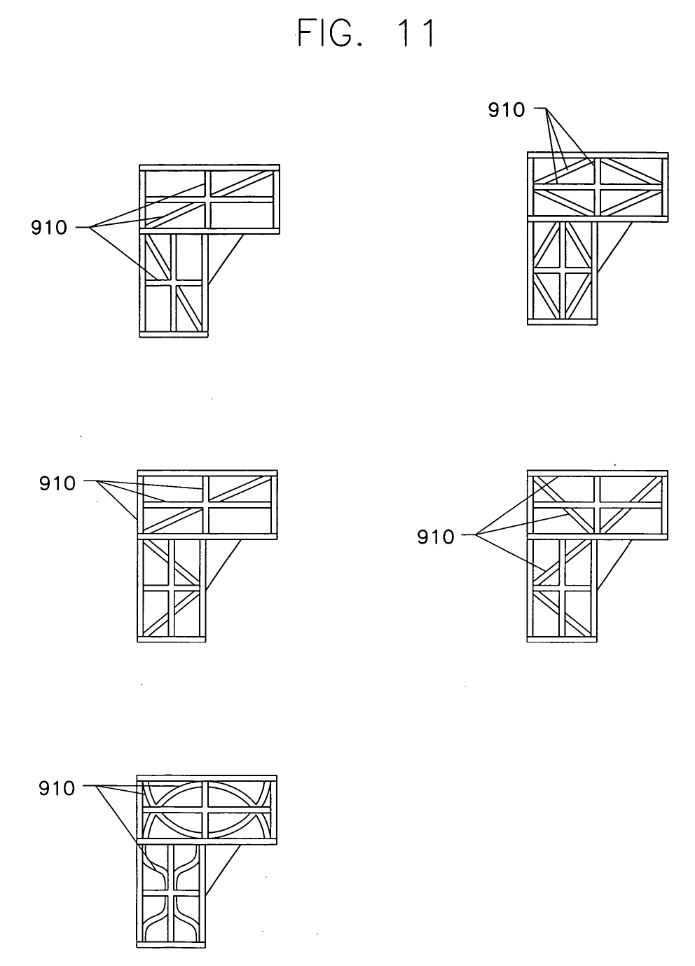

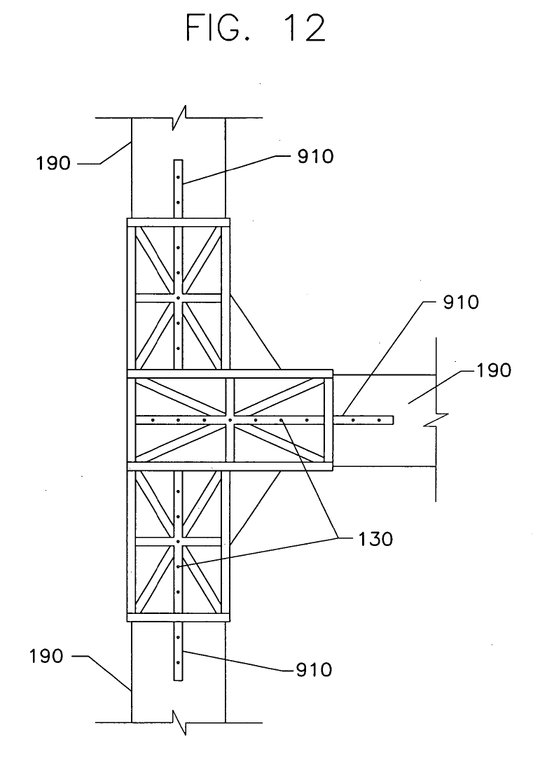

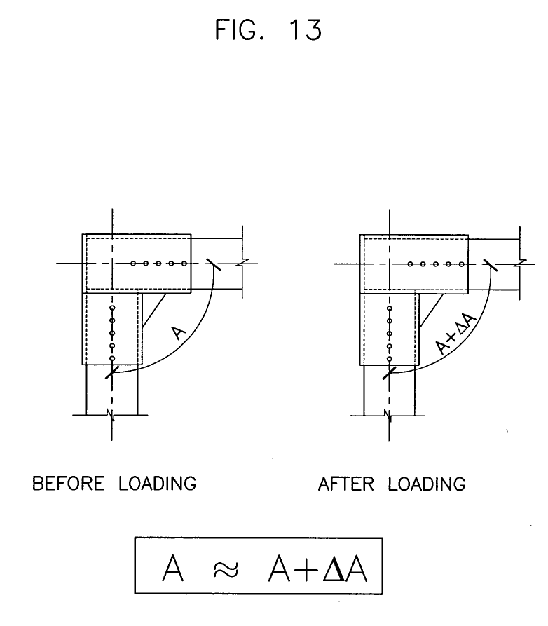

In yet other embodiments of the instant invention, a connector is provided with a “framed” face member comprising either straps, wires or rods, net or fiber mesh, or combination thereof, in lieu of a solid face member plate as shown in FIG. 9. The strap, wire, and net design, which all require less material than a plate design, may be preferable where the absolute weight of the connector is deemed excessive. Thus, straps 910 and wires or rods 940 may be designed to form a framed face member 920. One or more of the straps 910 may have optional holes 930 for fastening the framed face member 920 to the support member 190. The straps 910, wires or rods 940, and net or fiber mesh 950 may be attached to each other and other members of the connector by any of various means available to one of ordinary skill in the art, including, but not limited to, welding, bolting, screwing, riveting and lapping with adhesives. Exemplary configurations for framed face members such as straps 910 are provided in FIG. 10 and alternate designs for the straps are depicted in FIG. 11. Such options shown on FIGS. 10 and 11 are also applicable to wires and rods and net or fiber mesh configurations in some cases. Straps, wires or rods, and net or fiber mesh can be comprised of any material but it is preferrable that they comprise the same material as the other elements of the connector. As well, straps 910 may be designed to extend beyond the framed face member 920 and onto the support member 190 as shown in FIG. 12.

The use of straps, wires or rods, and net or fiber mesh is not limited to the faced members 110 and 120, but can also comprise the entire connector or other portions thereof. Such an application, however, can result in undesirable deformations when the connector is loaded, possibly resulting in a semi-rigid connection as opposed to the preffered rigid connection. Generally, a structural designer is charged to determine such behaviour and validate whether or not such a connection is acceptable based on a given performance criteria for a particular structure.

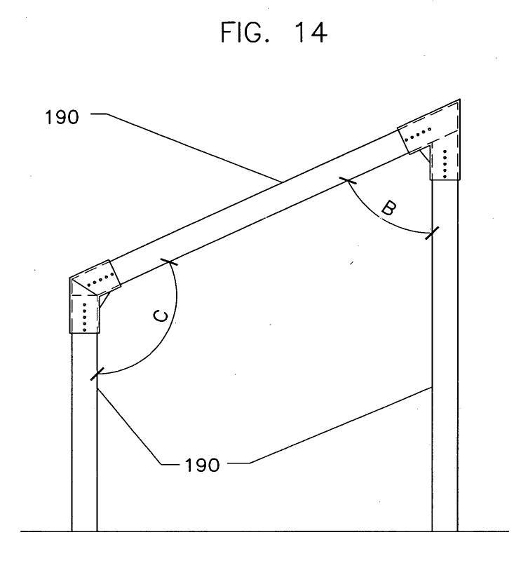

Without being held to or limited by theory, the inventive connectors are designed so that rotational forces, or “moments,” are able to be transferred between a beam and a column in a rigid or semi-rigid manner, such that after being subject to lateral loading, the angle A (FIG. 13) between the beam and column at the joint location remains minimal, preferably unchanged, compared to the angle in the unloaded state (A+ΔA). In other words, the connectors of the instant invention are designed to resist “moment” loads. The inventive connectors are thought to enable the transfer of rotational forces between support members (e.g., a beam and a column) by a bearing and tension mechanism. Thus, such a load transfer mechanism most often results in a bearing-type failure mode that results in a more durable and ductile connection.

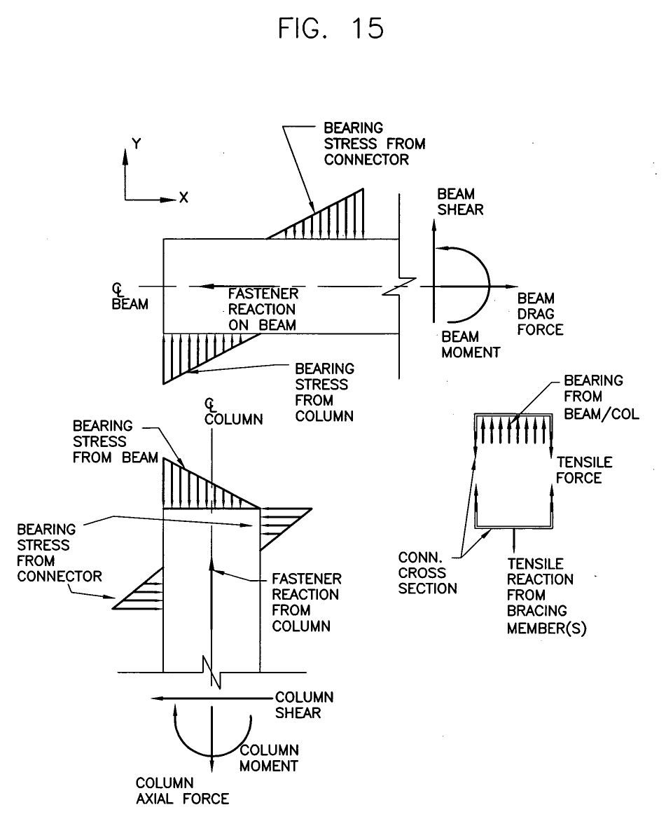

For most building design and construction, the angle A is designed at 90 degrees and remains about 90 degrees before and after the frame is loaded (FIG. 13). Current tolerances for ΔA for wood moment frames have not been established as wood moment frames have heretofore not been feasable. Current industry practice for ΔA for concrete and/or steel moment frames stands at a range of about 0.02 to 0.04 radii. It should also be appreciated that larger ranges of moment rotation may become acceptable and that alternate designs may require angles of more or less than 90 degrees as depicted, for example, in FIG. 14 (angles B and C). Thus, the scope of connectors of the present invention should not be limited to those with only about 90 degree angles.

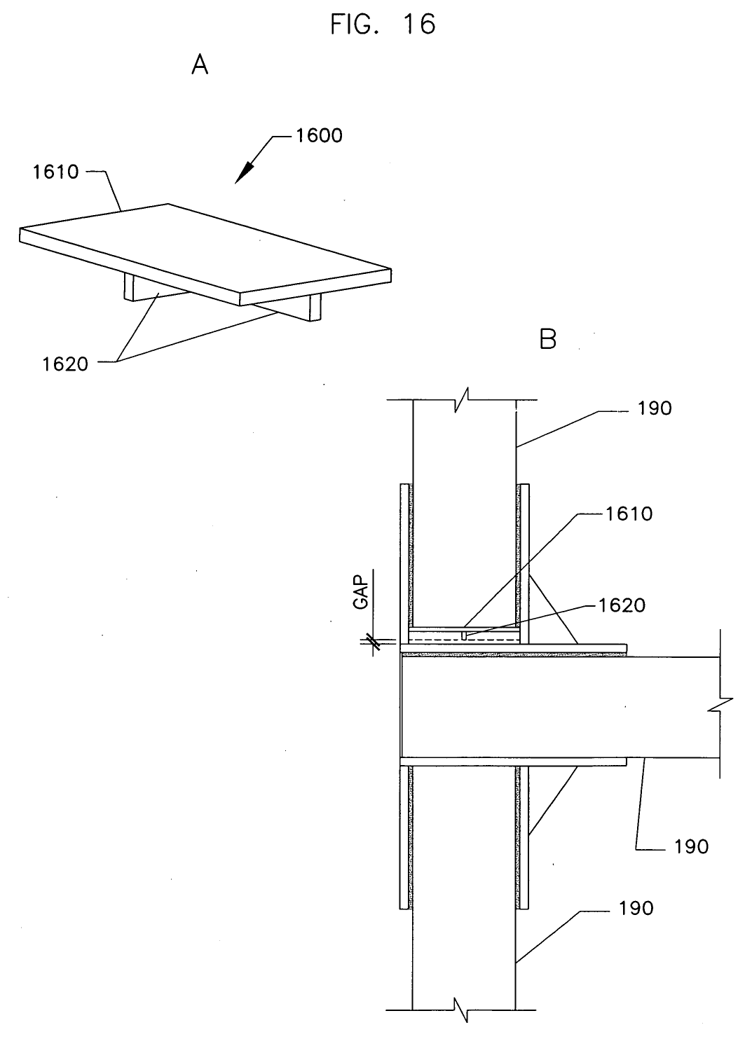

As shown in FIG. 15, without being limited to or bound by theory, a load path of a connector assembly in a moment frame in accordance with the invention may be described as follows. (The representations in FIG. 15 are approximations only and assume a single bay one-story moment frame with one wood beam supported by two wood columns on either end connected with the connector. Actual bearing distributions may vary depending on application-specific demands.) When a frame experiences a lateral load, the lateral forces for the structural system are imposed onto the beam through connections between the beam and the rest of the structural system. The beam experiences an axial load, or drag load, which is restrained by fasteners connecting the beam to both sides of the connector.

As the frame continues to drift laterally along the x direction (see FIG. 15), the angle between the beam-column interface naturally attempts to rotate. It is believed that at this point, the connector comes into effect. Namely, as the joint attempts to rotate, the top of the beam presses in bearing against the top flange of the connector and the left-most bottom face of the beam presses down in bearing on the wood column (FIG. 15).

The actual shape of the bearing distribution may vary depending on application specific demands, but it has been approximated as triangular in shape for purposes of illustration in FIG. 15. The bearing pressure against the flange of the connector is then resisted by internal tension along the two webs (i.e., face members) of the connector. The two webs, in turn, are resisted by the bottom flange, which in turn may be further supported by a brace member. The brace member becomes engaged in tension and diagonally transfers the tension load to the connector side that surrounds the column.

At this point, the bending moment is transferred from the beam to the column in the form of a tension force via the connector and bearing force via the beam-column interface. The brace member is restrained by the connector's flange on the column. This flange is then restrained by the two webs of the connector on either side of the column via tension. The two webs of connector are restrained by the left-most flange of the connector which presses to the x-direction in bearing on the wood column. When loaded in the opposite direction, the force vectors are opposite and the brace member transfers load through compression.

When a beam is installed to rest on top of a column and below another column from above, such as in multistory applications, it is possible that the vertical load from the column above can induce a signicant amount of stress onto the top of the beam reducing the amount of additional bearing stress that the connector can apply to the beam when subject to lateral loads. To mitigate this phenomenon, a “column seat” plate assembly 1600 as shown in FIG. 16A may be placed within the connector and slightly above the top of the beam's top surface supports the column's vertical load (FIG. 16B). The column seat plate assembly can be fastened to the other members of the connector by any number of ways including but not limited to welding, screwing, or molding with the entire assembly. This assembly can prevent the beam from experiencing load from the column above by transferring the columns vertical load to the face members of the connector instead.

The column seat assembly 1600 comprises a plate 1610. Since the vertical load from the column above can be relatively large in magnitude, the use of stiffener plates 1620 can be used to strengthen and stiffen the column seat plate 1610. Although FIG. 16 shows the stiffener plates to be cruciform in shape, they are not limited to such a configuration and can take any shape that effectively stiffens the column seat.

While the invention has been described in connection with specific embodiments thereof, it will be understood that it is capable of further modifications and this application is intended to cover any variations, uses, or alterations of the invention following. In general, the principles of the invention and including such departures from the present disclosure as come within known or customary practice within the art to which the invention pertains and as may be applied to the essential features hereinbefore set forth and as follows in the scope of the appended claims.

What is claimed:

1. A moment resisting connector for connecting two or more support members in a moment frame, comprising:
(a) a first angled face member and a second angled face member aligned substantially parallel to each other; and
(b) a plurality of flange members for enclosing the first and the second angled face members to form an angled enclosure with a plurality of entries capable of joining the two or more support members within the entries of the connector.

2. The connector according to claim 1 in which the face members and the flange members form a single unit.

3. The connector according to claim 1 in which the connector comprises steel, light-gauge metal, aluminum or a composite material.

4. The connector according to claim 1 in which the angled face members comprise a solid plate, straps, wires, rods, a net, fiber mesh or a combination thereof.

5. The connector according to claim 1 in which the angled face members further comprise holes to accommodate a fastening means.

6. The connector according to claim 5 in which the fastening means is selected from the group consisting of nails, screws, pins, bolts and rivets.

7. The connector according to claim 1 further comprising at least one brace member.

8. The connector according to claim 7 in which the at least one brace member comprises steel, light-gauge metal, aluminum or composite material.

9. The connector according to claim 1 in which the angled enclosure forms an angle of about 90 degrees.

10. The connector according to claim 1 in which at least one of the plurality of entries further comprises a liner.

11. The connector according to claim 10, in which the liner comprises epoxy, rubber, grout, plastic, foam, engineered wood or a combination thereof.

12. The connector according to claim 1 in which at least one of the plurality of entries further comprises a bearing distributor device.

13. The connector according to claim 1 in which the connector further comprises a column seat assembly.

14. The connector according to claim 1 in which the support members are beams or columns.

15. A method of constructing a moment frame, comprising:
(a) providing a first and a second support member,
(b) providing a moment resisting connector comprising:
(i) first angled face member and a second angled face member aligned substantially parallel to each other;
(ii) a plurality of flange members for enclosing the first and the second angled face members to form an angled enclosure with a plurality of entries; and
(c) joining the first and second support members, in any order, within the connector though any of the plurality of entries.

16. The method of claim 15 further comprising providing a third support member.

17. The method of claim 15 further comprising fastening the connector to the first and/or the second support members through the first and/or the second angled face members.

18. The method of claim 17 in which the first support member is a beam and the second support member is a column.

19. The method of claim 15 in which the first and second support members are columns.

20. The method of claim 19 further comprising inserting a column seat within the connector between the columns.

21. The method according to claim 15 in which the support members comprise wood.

22. A moment frame comprising:
(a) a first and a second support member, and
(b) a moment resisting connector comprising:
(i) first angled face member and a second angled face member aligned substantially parallel to each other;
(ii) a plurality of flange members for enclosing the first and the second angled face members to form an angled enclosure with a plurality of entries,
wherein the first and second support members are joined within the entries of the connector.

23. The method according to claim 22 in which the support members comprise wood.
